(19) United States
(12) Patent Application Publication
(10) Pub. No.: US 2002/0194298 A1
(43) Pub. Date: Dec. 19, 2002

(54) Selective narrative data base, system, and method

(76) Inventor: Dulcie Elizabeth Papsco, Forestville, CA (US)

Correspondence Address: Risto A. Rinne, Jr., Suite E, 2173 East Francisco Blvd., San Rafael, CA, 94901, US

(21) Appl. No.: 09/884,693

(22) Filed: Jun. 19, 2001

(51) Int. Cl. G06F 15/16

(52) U.S. Cl. 709/217; 709/247

(57) ABSTRACT

A system for the selection and subsequent receipt of audio signals over a common carrier such as the Internet or a telephone line by a user. The audio signals are those of a short story or other type of a narrative and may be received in real time and listened to while being received, or they may be compressed, as desired. Various methods whereby the user can subscribe to the system are disclosed. Apparatus disposed at the location of the user allows for the receipt and subsequent listening of the narrative. A transceiver and figurine which are adapted to respectively transmit and receive the audio signal, are provided. The audio signal file is transmitted by the transceiver to the figurine, which receives it and which is also adapted to enunciate the narrative for listening, such as to a child in a crib.

### BACKGROUND OF THE INVENTION

1. Field of the Invention

The present invention, in general relates to data bases and, more particularly, to a method of doing business that includes a data base and a menu that, upon payment of a fee, allows selection of a narrative which is output in the form of audio signals.

The benefits of reading to a person are well known. It can calm, soothe, and comfort the individual, regardless of their age.

It is also an active form of communication in that the hearer must concentrate sufficiently to develop mental imagery simultaneous with their hearing of the narrative. This makes the art of being read to a far more stimulating and growth provoking mode of communication than does watching television, for example.

Watching television (or going to a movie) is substantially a passive form of communication in which the required imagery is “handed” to the viewer. As such it is passive and does not well exercise either the mental faculties or the imaginative acuity of the viewer. It is even rumored that the excessive viewing of television actually tends to dull one's mental faculties.

The person watching television or a movie is not required to rely upon their faculties to any great extent, especially their faculty of imagination. They just sit and absorb what they are essentially handed. They are presented with sound and image and need only follow along, thinking as little as they wish.

However, people of all ages stand to benefit greatly and in many ways when they are read to. In particular, children greatly enjoy having a story read to them. This often occurs at bedtime and may help them to fall asleep.

Parents enjoy reading to their children when they are able but often they are not able to do so for a variety of reasons. For example, a parent may have a speech impediment such as a stuttering type of a defect or the parent may simply have poor reading skills. Embarrassment in such instances can preclude the parent from reading to their child.

As such, the child is not optimally encouraged to use their mental faculties that are related to imagination. When a person is read to the person forms mental images in response to the receipt of audible information. This then is an active form of communication. There are no images inherent in audible sounds. All such images must be formed by the hearer's imaginative faculties, hence, it the listener actively participates. Accordingly, the hearer is much more inclined to remember that which they have participated in the creation thereof. These benefits of being read to may be of especial benefit to children, yet they apply to some extent to people of all ages, of course.

Also, the range of reading material that is available may be limited. A child may not enjoy or be interested in listening to a story that they have heard before. The particular mood of the child may not match the reading material that is at hand. A parent may not be able to find an appropriate short story or other material that he or she can read to their child when the occasion arises.

Furthermore, a caregiver or a baby-sitter may wish to calm a rambunctious child or otherwise occupy one by reading to the child, especially at bedtime, but be unable to do so for any of the reasons mentioned hereinabove as well as for other reasons. For example, the caregiver or baby-sitter may need to attend to other children precisely at a time that would be ideal to read a story to another child who was just placed in their crib or bed, for example.

As was mentioned above, children especially enjoy having a story read to them at bedtime. In addition to hearing a story they greatly enjoy and even crave tactile stimulation. It is well known that copious amounts of touch are necessary for the proper development of a child. Touch is associated with being loved. Children love to be gently touched. That is why teddy bears and other toy figurines are so popular amongst children.

Stimulating the tactile sense, when combined with a calming story, can deeply relax a child and bring about a sense of inner peace. Therefore, regardless as to whether the parent or caregiver is able to read a story to a child, it is desirable for the child to receive positive tactile reinforcement, such as that which is derived from the child being able to hold a teddy bear or other type of a stuffed animal. Such benefits are well known in the infant toy arts.

As a result of the “bonding” that occurs between a child and its “teddy bear” or other stuffed animal or figurine, the child develops a fondness, perhaps even a reliance upon the figurine for a time during the child's normal healthy development. Therefore, the figurine (i.e., teddy bear or other stuffed animal) with which the child has bonded is especially well suited to the task of comforting the child, as that is its principle purpose.

If the figurine were able to be used as a part of a system to recite a story to the child, then maximum benefit to the child would occur absent the availability of the parent to be there and read the story.

In addition, there is another problem occurring in society, in general. For time immemorial, cultural tradition, legend, and myth have been passed on through the art of story telling. For some time now, especially in our fast paced culture, this art is gradually disappearing.

Ideally, a way of preserving stories, legends, and myths and of passing them on verbally, is needed. Such a method would be useful and help to maintain the cultural legacy of generations yet to come. It can make one both aware and proud of their ancestral roots.

As such, teenagers and even young adults would benefit from a system that allows them to hear relevant stories, legends, and myths. Teenagers, who often wish to appear “cool” to their peers would resist listening if their parents were to recite legends (i.e., stories) to them. However, they might well embrace a system that provided such access to them. Indeed, such a system could even be used for research projects, such as by college or other grade level students, to help research the culture, legend, and mythology of various cultures.

If such a system were accessible over a telephone connection, or through the Internet, people throughout the world could hear such stories and legends.

A great many subjects lend themselves well to the media of story telling. Not only cultural stories, but even religious legends and myths can be passed on from generation to generation if they were available to hear, on demand. People who are convalescing or bedridden would also stand to well benefit from listening to a narrative on a subject that interests them.

In addition to the above and other potential benefits of providing a system for providing narrative audio signals, there is a business need to provide such a system that provides access over the telephone or Internet. A subscription service would potentially compensate authors, service providers, as well as the recording artists themselves (i.e., those who lend their voices to animate the stories).

Accordingly, there exists today a need for a selective narrative data base, system, and method that helps to solve the aforementioned needs.

Clearly, such an apparatus, system, and method would be useful and desirable.

2. Description of Prior Art

Data bases are, in general, known. While the structural arrangements of the above known types of systems, at first appearance, may have similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a selective narrative data base, system, and method that is able to recite a narrative.

It is also an important object of the invention to provide a selective narrative data base, system, and method that is able to recite a short story.

Another object of the invention is to provide a selective narrative data base, system, and method that is able to recite a legend or a myth.

Still another object of the invention is to provide a selective narrative data base, system, and method that allows a user to access a particular narrative from amongst a plurality of narratives.

Still yet another object of the invention is to provide a selective narrative data base, system, and method that includes a menu to facilitate the selection of a narrative from amongst a plurality thereof.

Yet another important object of the invention is to provide a selective narrative data base, system, and method that is adapted to download a narrative to a user in real time.

Still yet another important object of the invention is to provide a selective narrative data base, system, and method that is adapted to download a narrative to a user in a compressed format (i.e., less than real time or in other than real time).

A first continuing object of the invention is to provide a selective narrative data base, system, and method that provides access to a narrative as part of a subscription service.

A second continuing object of the invention is to provide a selective narrative data base, system, and method that provides access to a narrative as part of a pay per access (i.e., per narrative) service.

A third continuing object of the invention is to provide a selective narrative data base, system, and method that provides access to a narrative as part of a pay per minute type of service whereby a shorter narrative is less expensive to listen to than would be a longer narrative.

A fourth continuing object of the invention is to provide a selective narrative data base, system, and method that provides access to a narrative over the Internet.

A fifth continuing object of the invention is to provide a selective narrative data base, system, and method that provides access to a narrative over a telephone line.

A sixth continuing object of the invention is to provide a selective narrative data base, system, and method that includes access to a server and a data base that includes a plurality of narratives stored in the data base, whereby a user can select and obtain one of the narratives that is stored in the data base.

A seventh continuing object of the invention is to provide a selective narrative data base, system, and method that includes a transceiver (in a home) that is connected to either a computer or to a telephone and which is adapted to receive a narrative audio signal from a server (i.e., a computer) that is disposed at a remote location, and wherein the server is adapted to access a data base to obtain the audio signal and to download it to the receiver, and wherein the transceiver is adapted to transmit the audio signal it has received to a remote device that preferably includes a figurine, such as a teddy bear, and wherein the remote device includes a receiver that is adapted to receive the audio signal and which also includes a speaker and means adapted for playing back the audio signal through the speaker.

An eight continuing object of the invention is to provide a selective narrative data base, system, and method that provides access to a narrative as part of a pay per minute type of a telephone service, such as by calling a “900” telephone number service whereby a shorter narrative is less expensive to listen to than would be a longer narrative.

Briefly, a selective narrative data base, system, and method that is constructed in accordance with the principles of the present invention has a server (i.e., a computer) that is connected to a data base. The data base contains a plurality of narratives which are stored as files of audio signals. A user contacts the server over a telephone line or over the Internet and, if authorized, is provided access to the narrative files in the data base. The user selects at least of the narrative files which is downloaded to the user either in real time or in a compressed format. The compressed format allows a transfer rate that is faster than the “real time” necessary to enunciate the narrative. The file preferably includes digital audio signals but it may also be an analog file of actual audio signals such as are suitable to drive a speaker. Accordingly, the file is adapted to be “played” to the user in real time. According to a particular preferred embodiment, a transceiver at the site of the user receives the audio signals that are downloaded from the server and transmits them to a figurine. The figurine contains a receiver and suitable circuitry and components to drive a speaker. The figurine is able to recite the narrative to a listener. The narrative audio files may be downloaded to the user and listened to as they are received or stored for future listening.

### BRIEF DESCRIPTION OF THE DRAWINGS

FIG. 1 is a block diagrammatic view of a selective narrative data base, system, and method for use over a telephone line.

FIG. 2 is a block diagrammatic view of a selective narrative data base, system, and method for use over an Internet.

FIG. 3 is a flowchart of a selective narrative data base, system, and method.

FIG. 4 is a block diagrammatic view of a selective narrative data base, system, and method which shows components thereof that are disposed at the site of a user.

### DETAILED DESCRIPTION OF THE INVENTION

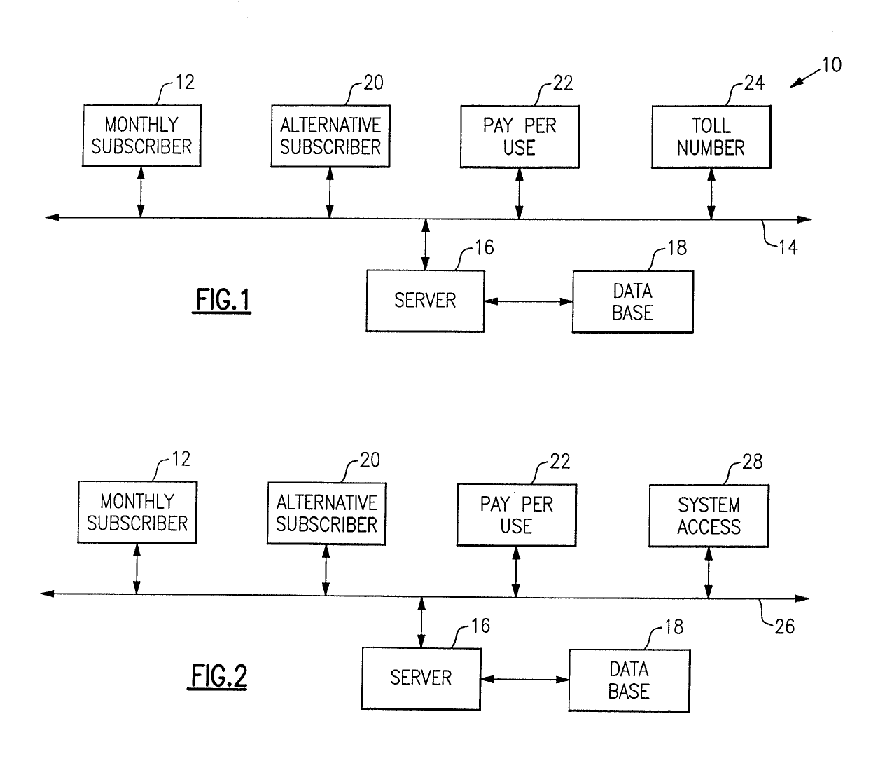

Referring to all of the drawings and in particular now to FIG. 1 is shown, a selective narrative data base, system, and method, identified in general by the reference numeral 10.

A monthly subscriber 12 uses a telephone line 14 to make connection with a server 16. The server 16 provides the monthly subscriber 12 (or any other type of a subscriber) with a selection of various narratives that are contained in a data base 18.

The monthly subscriber 12 pays for the right to access and obtain receipt of the narratives by paying a monthly subscription amount (i.e., a fee) to a company (not shown) that supplies and/or maintains the server 16 and the data base 18.

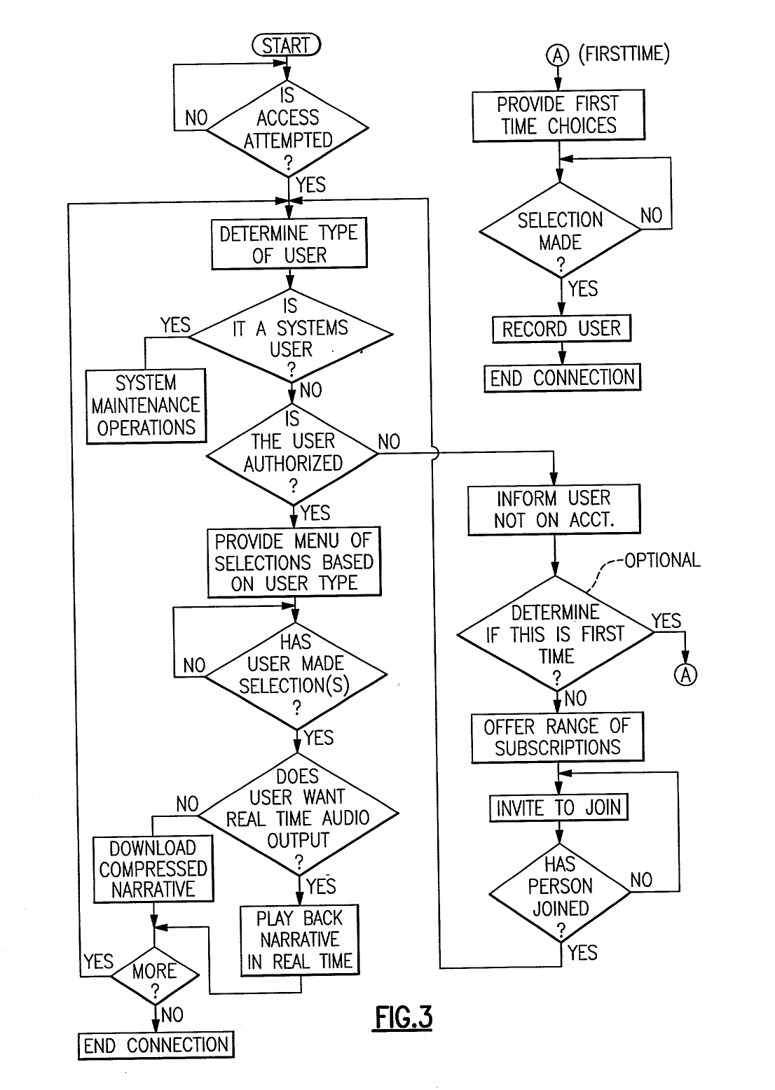

Referring now also to the flowchart of FIG. 3 is shown a possible logical structuring of the software of the server 16 in providing the monthly subscriber 12 (or other subscriber) with access to the system 10. This is discussed in greater detail hereinafter.

For now, let us assume that the monthly subscriber 12 has selected from a menu of choices that were presented, a particular narrative to listen to. That narrative is then played (i.e., transmitted) over the telephone line 14 in real time and the monthly subscriber 12 is able to listen to it over the telephone as it is being transmitted. Alternative methods of transmitting and of listening to the narrative are discussed hereinafter.

An alternative type of a subscriber 20 is also provided with similar access to the system 10. The alternative subscriber 20 may pay on a yearly basis or any desired and agreed upon interval.

A pay per use subscriber 22 pays for each narrative selection. The pay per use subscriber 22 may set up an account or simply pay for each connection made with the server 16 or prior to receipt of a transmission from the server 16. Payment can be made by charging each use against the account or, for example, with a credit card.

There are many reasons why the pay per use subscriber 22 (or any other subscriber) may desire to listen to a story being narrated. The subscriber 12, 20, 22 may want a child to hear the narrative so as to help the child fall asleep. Alternatively, the subscriber 12, 20, 22 may be doing a research project on, for example, the stories and legends that have been passed on from generation to generation of a particular culture and therefore be desirous to listen to some of these stories and legends.

A toll number subscriber 24 may be provided with access to the server 16 by using (i.e., dialing) a telephone number that they are then billed at a particular rate per minute of access time. Sometimes, such telephone numbers are referred to as “900” types of telephone numbers. The toll number subscriber 24 pays a predetermined rate per minute for access time to the system 10. This is different than the pay per use subscriber 22 who pays only for the selections heard, which may be at a flat rate per selection or also proportional to the length. However, the pay per use subscriber 22 is not accruing additional cost merely for looking at a menu of narrative selections that are available, whereas the toll number subscriber 24 is paying by the minute of time he is connected to the system 10, regardless of how that time is utilized.

Accordingly, listening in real time to a short narrative will cost the toll number subscriber 24 less than it would to listen to a longer type of a narrative.

Obviously, each of the various types of users 12, 20, 22, 24 uses their unique telephone number to connect with the server 16 thereby ensuring privacy and the receipt of the narrative by the intended recipient (i.e., user).

Referring now to FIG. 2, the selective narrative data base, system, and method 10 is shown substantially the same as in FIG. 1, except that access is provided over the Internet 26 and the toll number 24 is eliminated. While this type of a connection usually also includes a telephone or DSL type of a connection, the Internet 26 differs in that it allows generally for more rapid transfer of data and for the transfer of digital, rather than analog data.

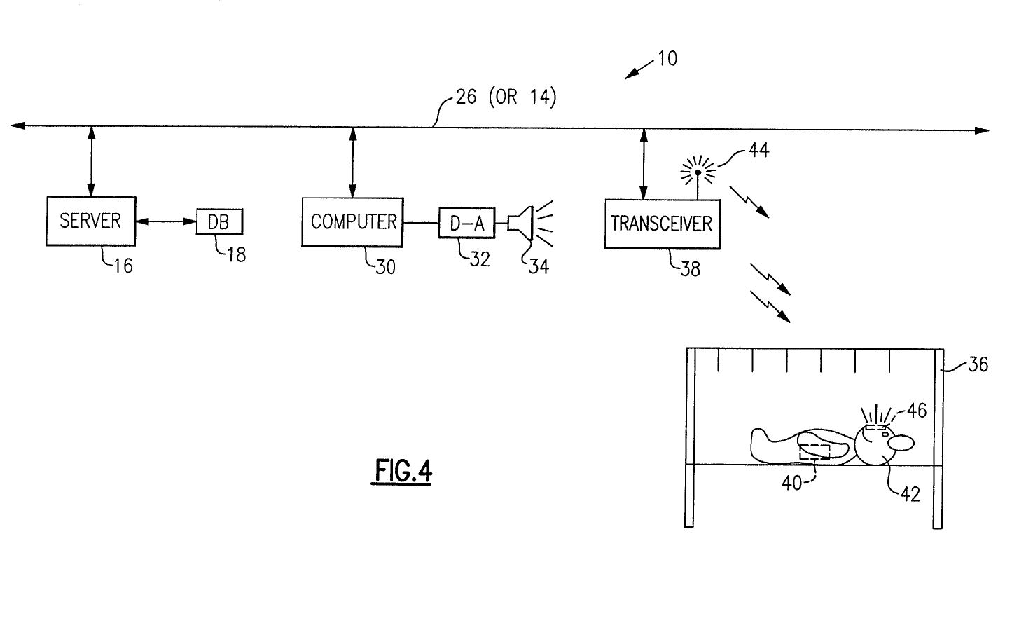

As is well known in the computer and the Internet 26 arts, each user 12, 20, 22, 24 would have a computer (see reference numeral 30, FIG. 4) that served as the interface between the user and the Internet 26 and which was adapted to make a data linkage connection with the server 16.

It is to be understood that the data base 18 includes a plurality of narratives that are each stored as separate files of audio signals. The audio signals may be either of an analog or a digital format. The system 10 allows the user 12, 20, 22, 24 to select which narrative or which narratives are to be downloaded (i.e., received by the user 12, 20, 22, 24).

The transfer of the narratives from the data base 18 to the user may be either in real time or it may be of a compressed format (such as are known in the transmission arts) so as to take less time than is required to actually listen to the narrative. The narrative, once received, may be stored in the user's computer 30 (or other equipment, as is described in greater detail hereinafter) in either a digital or an analog format and listened to later, when desired. If desired, once stored, it may be listened to repeatedly.

An authorized system access 28 person who, by use of a special access protocol and security code, is able to gain access to the server 16 and to the data base 18 so as to make updates or changes thereto. For example, newly authorized monthly subscribers 12 may be added to the server 16 (or deleted therefrom) or new narratives may be added to the data base 18 or old, unpopular ones deleted. The special access protocol necessary to accomplish this for the authorized system access 28 person is well known in the computer arts and there are many such options available to choose from.

It is similarly possible to update the server 16 and the data base 18 over the telephone line 14 or it can be done in person or, if desired, the server 16 can be provided with the Internet 26 connection (for making upgrades or to service the system 10). Service of the system 10 can then occur over the Internet 26 simultaneous with the ability to provide narrative service directly over the telephone line 14.

Referring again to FIG. 3, access either over the telephone line 14 or over the Internet 26 begins first by noting an attempt to gain access with the system 10. The next step is to then determine which type of a user (i.e., monthly 12, alternative 20, pay per use 22, toll number 24, or system access 28) is attempting to make the contact.

The flowchart does not provide operation for the authorized system access 28 person, as this protocol is determined by those who implement the software. However, software for the server 16 can be developed by those having ordinary skill in the art to provide whatever administrative and operational capabilities are required.

After determining which type of a user it is that is making contact, verification that the user is indeed authorized (i.e., is a currently paid monthly subscriber 12 or alternative subscriber 20 or has paid for the pay per use 22 attempt, or is calling over the toll number 24) is accomplished after which the user is provided with a menu of narrative choices that are available. If desired, the pay per use 22 subscriber may be provided with a menu and not asked to pay until after having made selection of at least one narrative to listen to.

The system waits for the user to make the selection or selections and then it determines how the narrative is to be delivered, either as a real time analog file of audio signals that are transmitted in real time over the telephone line 14 or as a digitally compressed file of analog signals that are transmitted rapidly over the Internet 26. Once proper determination is made (which may require input from the user) the narrative file is then sent to the user. If the user wants to view, make, or receive yet further selections, the process is repeated until the user desires to end the connection with the server 16.

There are also many options available which are briefly discussed, some of which are shown in the flowchart. For example, if the user is not authorized, the user may be provided with an opportunity to open and pay for an account and then be granted access. If the user is attempting to make contact with the system 10 for the first time, a special promotion, such as a free initial trial listening of one narrative may be offered to the first time user. A recordation is then made that includes identification of the first time user so as to prevent any future attempts at obtaining free access to the system 10. Clearly, there is a vast opportunity and many variations in how the system 10 is configured and promoted are certainly possible.

Referring now to FIG. 4, a more detailed view of portions of the selective narrative data base, system, and method 10 that are disposed at the site of the user 12, 20, 22 (or 24 if the telephone line 14, shown in parentheses, is used) are shown. The computer 30 is shown which is adapted to receive the narrative in digital format over the Internet 26. The computer 30 includes components parts, either internal or externally disposed, that include a digital to analog converter 32 which is adapted to decompress the digital file of the narrative (if necessary) and to convert it into a purely analog type of a signal that is suitable for driving a speaker 34. The analog signal may have to be amplified for proper listening. These technologies are well known to those in the computer and audio arts.

A preferred option for infants and children (not shown) that, for example, may be residing in a crib 36 includes the use of a transceiver 38 proximate a common carrier (either the telephone line 14 or the Internet 26). A receiver 40 (shown in dashed lines) is preferably contained within a figurine 42. The preferred type of a figurine 42 may include a teddy bear, a doll, or some other likeness.

In use, the transceiver 38 is connected to either the Internet 26 or the telephone line 14 and it accordingly, acquires the audio file of the desired narrative. Assuming, for example, that the narrative is acquired in real time, it is simultaneously transmitted by the transceiver 38 as soon as the transceiver 38 receives it. The transceiver 38 may use any known type of a modality to transmit the audio file of the narrative to the receiver 40. The use of either amplitude modulation (AM) or frequency modulation (FM) types of a radio frequency 44 are well known and preferred.

The audio file of the narrative is received (i.e., acquired) by the receiver 40 that is disposed (preferably) in the figurine 42. The figurine 42 must be disposed sufficiently near to the transceiver 44 to acquire the audio file. The receiver 40 demodulates the radio frequency 44 signal, as is well known in the radio frequency and transmission arts. The receiver 40 includes the necessary electrical circuitry to perform the necessary amplification of the pure audio signal portion of the narrative (i.e., that portion which remains after demodulation has occurred). The narrative is then played (i.e., enunciated) to the child in the crib 36 through an internal speaker 46 that is included in the figurine 42.

Accordingly, the child perceives the figurine 42 as being adapted to recite the narrative (i.e., a bedtime story) to him or to her. This is far more intimate and reassuring than would be listening to a tape recorder, for example. This calms the child, helps the child go to sleep, comforts and amuses the child, and strengthens the bond between the child and the figurine 42, while freeing any parent or caregiver (not shown) for other purposes.

Accordingly, a method of conducting business is provided whereby there are clear opportunities to profit by selling access to the narratives to the various subscribers 12, 20, 22, 24.

Similarly, authors and recording artists can be compensated (perhaps receive a stipend for each transmission of any selection of an audio file contained in the data base 18 that they have helped to create). They may also be compensated through the notoriety they gain. For example, if a celebrity were to record a narrative in his or her voice, the public would become accustomed to hearing that person's voice. Also at the start of each narrative, the necessary acknowledgment of the recording artist, the author, and any other desired credits may also be made.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A selective narrative data base and system, comprising:
(a) means for providing access to a common carrier, said common carrier adapted to transmit a file of audio signals from a first location to a second location;
(b) a server connected to said common carrier at said first location;
(c) a data base connected to said server, said data base including said file of audio signals and wherein said file of audio signals is sufficient to encode a narrative; and
(d) means for transmitting said file of audio signals through said common carrier to a user disposed at said second location.

2. The selective narrative data base and system of claim 1 wherein said common carrier includes a telephone line.

3. The selective narrative data base and system of claim 1 wherein said common carrier includes an Intenet.

4. The selective narrative data base and system of claim 1 wherein said data base includes a plurality of said files, each of said plurality of files including a compilation of audio signals sufficient to encode a different narrative.

5. The selective narrative data base and system of claim 1 wherein said file includes a short story.

6. The selective narrative data base and system of claim 1 wherein said means for transmitting said file of audio signals through said common carrier to a user disposed at said second location includes means for providing said user with said file in real time.

7. The selective narrative data base and system of claim 1 wherein said means for transmitting said file of audio signals through said common carrier to a user disposed at said second location includes means for providing said user with said file in a compressed format that requires less time than is required to listen to said narrative.

8. The selective narrative data base and system of claim 1 including means for subscribing wherein authorization to obtain access to said file is denied to said user until said user has complied with said means for subscribing.

9. The selective narrative data base and system of claim 8 wherein said means for subscribing includes a monthly subscription.

10 The selective narrative data base and system of claim 8 wherein said means for subscribing includes a subscription for a time interval that is other than monthly.

11. The selective narrative data base and system of claim 8 wherein said means for subscribing includes paying for each access to said system.

12. The selective narrative data base and system of claim 8 wherein said means for subscribing includes means for paying for the amount of time said access to said system is provided.

13. The selective narrative data base and system of claim 12 wherein said means for paying includes providing access via a telephone number that includes a charge that is made for each unit of elapsed time and wherein the elapsed time accrues whenever said user is connected to said server.

14. The selective narrative data base and system of claim 1 including means for receiving said file of audio signals at said second location.

15. The selective narrative data base and system of claim 14 wherein said means for receiving includes a transceiver.

16. The selective narrative data base and system of claim 15 wherein said transceiver is adapted to transmit said file of audio signals to a third location.

17. The selective narrative data base and system of claim 16 wherein said third location includes means for receiving said transmitted file of audio signals said transceiver and including means for converting said transmitted file into a format adapted for listening to said narrative.

18. The selective narrative data base and system of claim 17 wherein said third location is disposed in a figurine.

19. The selective narrative data base and system of claim 18 wherein said figurine includes a stuffed figurine.

20. A method of providing a selective narrative data base and system, comprising the steps:
(a) providing access over a common carrier;
(b) providing a server connected to said common carrier;
(c) providing a data base that is connected to said server, said data base including a plurality of files of audio signals sufficient to encode a narrative;
(d) providing means for selecting a particular file of audio signals by a user from said plurality of files; and
(e) transmitting said particular file of audio signals to said user using said common carrier.
